(19) United States
(12) Patent Application Publication
(10) Pub. No.: US 2019/0038491 A1
(43) Pub. Date: Feb. 7, 2019

(54) MATTRESS FOR PREVENTING AND TREATING BEDSORES

(71) Applicant: Guy Wackermann, Monswiller (FR)

(72) Inventor: Guy Wackermann, Monswiller (FR)

(21) Appl. No.: 16/074,157

(22) PCT Filed: Feb. 17, 2017
(86) PCT No.: PCT/FR2017/050364

§ 371 Date: Jul. 31, 2018

(30) Foreign Application Priority Data
Feb. 19, 2016 (FR) FR1670053

(51) Int. Cl. A61G 7/057

(52) U.S. Cl. CPC A61G 7/05715; A47C 31/007

(57) ABSTRACT

The present invention relates to a mattress for preventing and treating bedsores comprising a main body (1) and an exchangeable element (2, 3, 4), said exchangeable element (2, 3, 4) comprising an absorbent composition (7) and a disinfectant composition (8).

The present invention also relates to a method for manufacturing such a mattress, and comprising the following steps:
production of the main body (1), covered with a cover (5), in particular in plasticized jersey, with a housing for at least one exchangeable element (2, 3, 4),
production of an exchangeable element (2, 3, 4) in honeycomb cardboard or viscoelastic cellular foam,
deposition of an absorbent composition (7) in the exchangeable element,
deposition of a disinfectant composition (8) on the absorbent composition,
arrangement of an envelope (11) around the exchangeable element (2, 3, 4), made in particular of a permeable nonwoven textile,
placement of the exchangeable element (2, 3, 4) in the car responding housing of the main body (1).

The present invention is in the field of medical bedding. It relates to a mattress for preventing and treating bedsores.

People confined to bed for long periods of time are prone to bedsores, skin lesions that may even require surgical treatment. The risk is even greater when the subjects suffer from urinary incontinence. Indeed it is important to maintain good skin hygiene in order to prevent maceration, conducive to the development of bedsores.

Preventing and treating bedsores require frequent cleaning and sterilization of mattresses. In the document FR2713935, the inventor of the present application has proposed a device comprising a box to be placed under the bedridden person, provided with an absorbing and disinfectant composition. But this device can easily move when the patient moves and no longer be able to collect all the urine and feces. In addition, this solution is not comfortable for the bedridden person.

The present invention aims to overcome at least in part these disadvantages. For this purpose, it proposes an absorption and disinfection element, usable in a mattress for preventing and treating bedsores, comprising an absorption compartment comprising an absorbent composition and a disinfection compartment, comprising a disinfectant composition, characterized in that it comprises a water-soluble film separating said absorption compartment from said disinfection compartment.

With these provisions, body fluids such as feces, urine, sweat and the like are absorbed and disinfected by the absorption and disinfection element. The skin hygiene of the bedridden person is therefore preserved, in particular preventing maceration, and bedsores can be avoided and/or treated.

According to other features:
said disinfection compartment, can be divided into a plurality of subcompartments that are watertight with respect to each other ; thus during the transport or storage in vertical position of the absorption and disinfection element, the distribution of the disinfectant composition remains sufficiently uniform and the disinfection capabilities of the absorption and disinfection element are preserved over the entire disinfection compartment,
said disinfection compartment may comprise at least one, preferably two reinforcements, for better mechanical support of the buttocks of the bedridden person.

The present invention also relates to a mattress for preventing and treating bedsores comprising a main body and an exchangeable element, said exchangeable element comprising an absorbent composition and a disinfectant composition.

Thanks to these provisions, body fluids such as feces, urine, sweat and the like are absorbed and disinfected by the exchangeable elements. The skin hygiene of the bedridden person is therefore preserved, in particular preventing maceration, and bedsores can be avoided and/or treated.

According to other features:
said mattress may comprise three exchangeable elements placed along a longitudinal median axis at both ends and in the center of the mattress, making it possible to cover the areas of the human body that distribute almost all the body fluids,
said exchangeable element may comprise a honeycomb cardboard or cellular foam structure, constituting a receiving basin for the absorbent and disinfectant compositions,
said mattress may comprise a water-soluble film separating said absorbent composition from said disinfectant composition, in order to prevent the absorbent and disinfectant compositions from mixing during the transport of said exchangeable element,
said absorbent composition may comprise a vegetable absorbent, in particular corn cob, and may be in the form of granules, which makes the absorbent composition more effective and easier to handle and biodegradable,
said disinfectant composition may contain sodium perborate, making it possible to obtain a cheap and effective disinfectant by hydrolysis,
said disinfectant composition may further comprise an activator, for example a TAED, making it possible to activate the hydrolysis at a lower temperature, and thus to improve the disinfection efficiency,
said disinfectant composition may contain an ampholyte, in particular betaine, in order to accelerate the reaction producing the disinfectant by hydrolysis of sodium perborate,
said exchangeable element may comprise an envelope, in particular of permeable nonwoven textile, constituting a simple and robust embodiment of the invention, and making it possible to hold the exchangeable element,
said main body may comprise a plasticized jersey cover, which makes it possible to protect the main body and avoid having to sterilize it too often.

The present invention finally relates to a method for manufacturing a mattress according to the invention, comprising the following steps:
production of the main body, covered with a cover, in particular in plasticized jersey, with a housing for an exchangeable element,
production of an exchangeable element in honeycomb cardboard or viscoelastic cellular foam,
deposition of an absorbent composition in the exchangeable element,
deposition of a disinfectant composition on the absorbent composition,
arrangement of an envelope around the exchangeable element, made in particular of a permeable nonwoven textile,
placement of the exchangeable element in the corresponding housing of the main body.

Thanks to these provisions, a mattress according to the invention can be easily manufactured from materials of conventional use in the field of hospital bedding. The present invention will be better understood when reading the detailed description that follows, with reference to the appended figures in which

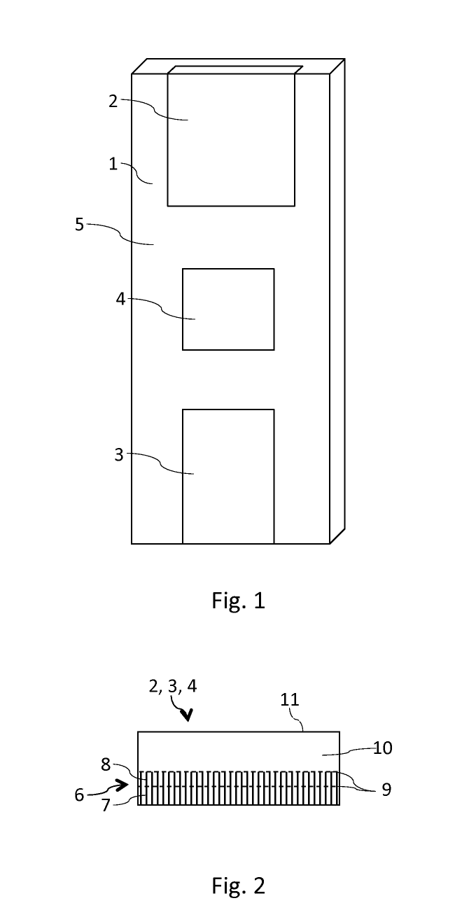

FIG. 1 is a perspective view of a mattress according to a preferred embodiment of the invention.

FIG. 2 is a sectional view of an exchangeable element according to a preferred embodiment of the invention.

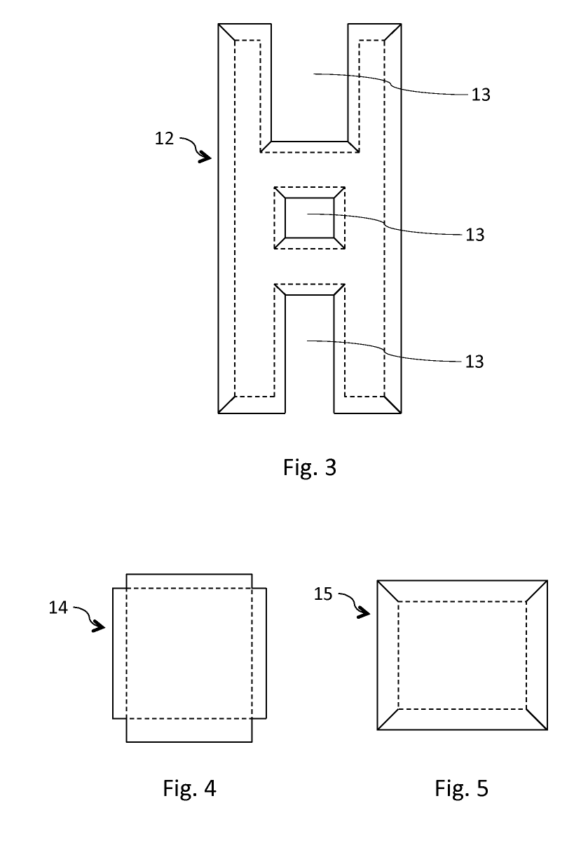

FIG. 3 is a top view of the main part of a cover according to a preferred embodiment of the invention,

FIG. 4 is a top view of a second part of a cover according to a preferred embodiment of the invention.

FIG. 5 is a top view of a third portion of a cover according to a preferred embodiment of the invention.

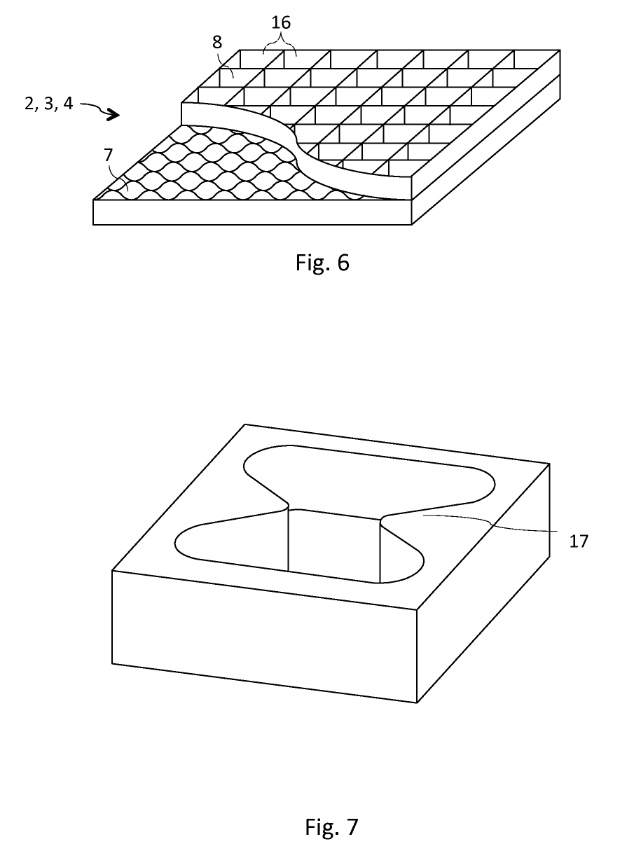

FIG. 6 is a perspective view of an exchangeable element according to a preferred embodiment of the invention.

FIG. 7 is a perspective view of an exchangeable element according to another preferred embodiment of the invention.

The mattress according to the invention comprises a main body 1 and an exchangeable element. In a preferred embodiment shown in FIG. 1, three exchangeable elements are used. They are placed along a longitudinal median axis at both ends and in the center of the mattress. Thus the upper exchangeable element 2 may correspond to the location of the head and the shoulders, the lower exchangeable element 3 may correspond to the location of the feet of the bedridden person, and the central exchangeable element 4 is able to collect the urine and feces.

Different types of mattresses can be considered without leaving the scope of the present invention, simply by adapting the dimensions of the main body 1 and the exchangeable element 2, 3, 4, as well as the placement and the number of exchangeable elements 2, 3, 4. Examples of applications may be, but are not limited to, hospital bed mattresses, operating tables, supports for long-term bedridden people, mattresses for children, incubator mattresses.

The main body 1 may comprise housings to receive the exchangeable elements 2, 3, 4, so that the exchangeable elements 2, 3, 4 can be inserted into the main body 1, and that the entire mattress is substantially flat on its upper side. Thus the exchangeable elements 2, 3, 4 are locked in position and comfort for the bedridden person is close to the comfort of a conventional mattress.

The main body 1 can be covered with a cover 5, the latter being made so as to follow the shape of the housings present in the main body 1 to accommodate the exchangeable elements 2, 3, 4.

The main body 1 can be made of viscoelastic foam, or any other material usually used to make mattresses. The cover 5 can be made of plasticized jersey, known under the name of Dartex (registered trademark).

FIG. 2 shows the detail of the inside of an exchangeable element 2, 3, 4 according to a preferred embodiment of the invention The exchangeable element 2, 3, 4, or absorption and disinfection element, comprises an absorption and disinfection module 6, with an absorption compartment 7 comprising an absorbent composition 7 and a disinfection compartment 8 comprising a disinfectant composition 8. In the embodiment of FIG. 2, a water-soluble film 9 is placed between the absorbent composition 7 and the disinfectant composition 8 to ensure that the absorbent composition 7 and disinfectant composition 8 remain in place and do not mix during the transport of the exchangeable elements 2, 3, 4. As soon as the exchangeable element is placed in the mattress 1, the first flow of the urine reaches the water-soluble film 9 and dissolves it. Thus the urine reaches the absorbent composition, where it is absorbed.

The exchangeable element 2, 3, 4 may also comprise, above the absorption and disinfection module 6, a sealing top 10, Finally, the absorption and disinfection module 6 and the sealing top 10 of the exchangeable element 2, 3, 4 can be wrapped together in an envelope 11.

The absorption and disinfection module 6 can be made, for example, of honeycombed cardboard or cellular foam, for example a high-resilience foam of 80 kg/m3, referred to as HR 80. The use of honeycomb cardboard results in a firmer exchangeable element 2, 3, 4. It may therefore be advisable to choose honeycomb cardboard for the central exchangeable element 4 located in the center of the mattress, where the mattress is usually softer, and the cellular foam for the exchangeable elements 2, 3 located at the ends of the mattress.

In an embodiment shown in FIG. 6, the disinfection compartment 8, is divided into a plurality of sub-compartments 16 watertight with respect to each other. These sub-compartments allow that during the handling of the exchangeable element 2, 3, 4, for example during its transport or during its storage in a vertical position, the distribution of the disinfectant composition 8 remains sufficiently uniform over the entire disinfection compartment 8. In particular, this allows the entire disinfection compartment 8, once placed in a main body 1 and in use, to keep its disinfection capabilities.

In another embodiment shown in FIG. 7, the disinfection compartment 8 may comprise at least one, preferably two structural reinforcements 17, for example made of cardboard, allowing better mechanical support of the buttocks of the bedridden person. These reinforcements reduce the available section for the disinfectant composition 8, which however remains present in sufficient quantity. Advantageously, the absorption compartment 7 may extend over the entire section of the exchangeable element 2, 3, 4, in particular in the case where the absorbent composition 7 comprises corn cob, which, while being inexpensive, is sufficiently consistent to resist compression, and to support the body of the bedridden person. Thus the reinforcements 17 have a thickness reduced to that of the disinfection compartment 8, which makes it easier to give them sufficient mechanical strength than if they had a thickness corresponding to the sum of the two compartments.

The sealing top 10 may also be made of a HR 80 foam. This foam comprises open cells, and is preferred for its chemical and micro-organic inertia on the one hand, and for its flexibility to the touch on the other hand. It avoids the bedridden person points of hard pressure that cause redness and bedsores. The envelope 11 may be made of permeable nonwoven textile.

The absorbent composition 7 may comprise a vegetable compound, for example corncob as sold by the company Eurocob (registered trademark). Activated charcoal with a very large absorbent capacity can be added to the absorbent compound if the exchangeable element is to be used for a long time.

In a preferred embodiment of the invention, the disinfectant composition 8 comprises powdered tetra hydrated sodium perborate. In contact with water, sodium perborate hydrolyzes to release peracetic acid, which is a disinfecting biocide. In order to activate the formation of peracetic acid, the disinfectant composition 8 may also comprise an activator such as tetraacetylethylenediamine, also called TAED, which allows the hydrolysis to begin at a lower temperature. Finally, the disinfectant composition 8 may also include an ampholyte such as betaine, whose role is to accelerate the reaction. Sterilization is therefore automatic, by a systematic and total germicidal action. The dosage of the disinfectant composition 8, in particular the concentrations of sodium perbarate, TAED and betaine can be adapted according to the use of the exchangeable element 2, 3, 4.

The absorbent composition 7 and disinfectant composition 8 as described in their various alternatives in the preceding paragraphs can also be used in the context of an absorption and disinfection element outside a mattress according to the invention, for example placed on a mattress. Comfort is less good for the patient, but the absorption and disinfection efficiency is similar.

The production of a mattress may comprise the following steps:
production of the main body 1, for example made of viscoelastic foam, with a housing for an exchangeable element 2, 3, 4,
production of a cover 5 in plasticized jersey conforming to the shape of the main body 2. As shown in FIG. 3, the cover 5 may comprise a main portion 12 comprising openings 13 at the location of the exchangeable elements 2, 3, 4. As shown in FIG. 4, the cover 5 may comprise a second and a third parts 14, 15 corresponding to the exchangeable elements 2, 3 and 4, which are to be glued or sewn into the openings of the main part.
production of an exchangeable element 2, 3, 4 in honeycomb cardboard or in viscoelastic or viscostatic foam.
deposition of an absorbent composition 7 in the exchangeable element 2, 3, 4,
deposition of a disinfectant composition 8 on the absorbent composition 7,
arrangement of an envelope 11 made of nonwoven textile around the exchangeable element 2, 3, 4,
placement of the exchangeable element 2, 3, 4 in the corresponding housing of the main body 1.

After use, the central exchangeable element 4, which in a preferred embodiment of the invention is entirely made of biodegradable elements, may be incinerated. The exchangeable elements 2, 3 may be sterilized and reused. The invention thus makes it possible to avoid sterilizing the complete mattress by replacing this step with a simple replacement of a disposable exchangeable element 2, 3, 4, and/or a sterilization of an exchangeable element 2, 3, 4, which is simpler and less expensive.

In case of saturation of the exchangeable element 2, it loses its disinfectant function. However, it remains bacteriostatic, that is to say that it does not allow bacteria to develop, which is essential in the prevention and treatment of bedsores.

1. An absorption and disinfection element, usable in a mattress for preventing and treating bedsores, comprising; an absorption compartment comprising an absorbent composition; a disinfection compartment, comprising a disinfectant composition; and a water-soluble film separating said absorption compartment from said disinfection compartment.

2. An element according to claim 1, further comprising a honeycomb cardboard or a cellular foam structure.

3. An element according to claim 1, wherein the absorption compartment comprises a cardboard honeycomb or a cellular foam structure.

4. An element according to claim 1, wherein the disinfection compartment (8) is divided into a plurality of sub-compartments (16) watertight with respect to each other.

5. An element according to claim 1, wherein said disinfection compartment comprises at least one, preferably two reinforcements.

6. An element according to claim 1, wherein the absorbent composition comprises a vegetable absorbent, in particular corn cob, and is in the form of granules.

7. An element according to claim 1, wherein the disinfectant composition contains sodium perborate.

8. An element according to claim 1, wherein the disinfectant composition contains an ampholyte, in particular betaine.

9. An element according to claim 1, comprising an envelope, in particular made of permeable nonwoven textile.

10. A mattress for preventing and treating bedsores, comprising: a main body; and at least one element according to claim 1, wherein said element is integrated in the mattress in an exchangeable manner.

11. A mattress according to claim 10, further comprising three exchangeable elements placed along a longitudinal median axis at both ends and in a center of the mattress.

12. A mattress according to claim 10, wherein the main body comprises a cover in plasticized jersey.

13. A method for manufacturing a mattress according to claim 10, comprising the following steps:
production of the main body, covered with a cover, in particular in plasticized jersey, with a housing for at least one exchangeable element,
production of an exchangeable element in honeycomb cardboard or viscoelastic cellular foam,
deposition of an absorbent composition in the exchangeable element,
laying of a water-soluble film on the absorbent composition, deposition of a disinfectant composition on the absorbent composition,
arrangement of an envelope around the exchangeable element made in particular of a permeable nonwoven textile,
placement of the exchangeable element in the corresponding housing of the main body.
